(19) United States
(12) Patent Application Publication
(10) Pub. No.: US 2010/0208058 A1
(43) Pub. Date: Aug. 19, 2010

(54) MONITORING THE COLOR IMPRESSION OF MULTICOLOR PATTERNED AREAS

(75) Inventor: Robert Massen, Ohningen (DE)

Correspondence Address: LAW OFFICES OF STUART J. FRIEDMAN, 28930 RIDGE ROAD, MT. AIRY, MD, 21771, US

(73) Assignee: Baumer Inspection GmbH, Konstanz (DE)

(21) Appl. No.: 12/450,363

(22) PCT Filed: Mar. 20, 2008
(86) PCT No.: PCT/EP2008/002296

§ 371 Date: Apr. 26, 2010

(30) Foreign Application Priority Data
Mar. 24, 2007 (DE) 10 2007 014 735.1

(51) Int. Cl. G06K 9/00; G06F 15/00; H04N 7/18

(52) U.S. Cl. 348/135; 382/165; 358/1.9; 348/E05.031

(57) ABSTRACT

A method and an arrangement for testing the quality of multicolor patterned surfaces with an n-channel imaging sensor such as a color camera or an imaging spectrometer. The method determines from the captured images the deviations of the color/spectral statistics and of the image sharpness with respect to references and, before an assessment, converts at least one of the deviations or threshold values using a transformation which emulates the genetically and/or culturally specific perception of the targeted customer groups. The method further allows a quality produced to be associated with a genetically and/or culturally specific group of customers who accept this quality in terms of their perception of multicolor patterned surfaces.

Automatic monitoring of the overall color impression of multicolor surfaces even today presents a big problem in the printing on decorative papers and decorative films for the flooring and laminate industries, in the production of multicolor patterned plastic or rubber floor coverings and, in general, in the manufacturing of products having a multicolor patterned surface. The assessment of natural multicolor surfaces such as natural stones, types of marble, wooden surfaces, etc. and similar color textures is also not possible today since the traditional colorimetry is specified and standardized only for single-color surfaces.

Even the so-called imaging spectroscopy, which measures with a high spatial resolution a spectrum for each picture element captured by the camera employed, is not capable of generating measured values which correspond sufficiently precisely to the color impression of the human visual system when viewing colored patterned surfaces, in particular surfaces with fine patterns.

The manufacture and automatic monitoring of the aesthetic quality of the surfaces of such products therefore even today requires visual comparisons by trained and experienced specialists and is therefore costly and imprecise and generates only subjective and qualitative quality data.

These limitations of the currently known metrology are based on the fact that these techniques do not or not sufficiently take important special features of the human visual and cognition system in the viewing of multicolor patterned surfaces into consideration.

German Patent Application 11 2004 000 051.3 discloses a method and an arrangement which considers the peculiar physiological effect that small changes in the physical image sharpness, which can not be perceived as such by the human eye, lead to an impression as if the color shade has shifted. For example, when a multicolor decorative paper is printed, a human being will see a shift in the color shade in comparison to the reference (a so-called color cast) although the physical color composition has not changed and, thus, both the classical colorimetry and the more recent imaging colorimetry do not measure a color shift. These small changes in the image sharpness cause the impression of a color shift even in experienced printing specialists since even their eye does not recognize this change in image sharpness as such. Accordingly, the printers will take corrective action with respect to the formulation and dosage of color pigments although the physical cause is not to be found here, but a search should be made for small registration errors between the individual printing stages. The above-mentioned German Patent Application 11 2004 000 051.3 shows a teaching to remedy this misguidance in that it measures the stability of the color statistics and that of the image sharpness at the same time using imaging and color-capable sensors such as, e.g., color cameras, and represents it in comparison to the reference.

This makes a tool available to the printer which allows him/her to correctly classify the visually perceptible color shifts and to correct the printing process at the right place:

(a) by a change in the pigments and the dosage thereof when a change in the color statistics is measured;

(b) by a change of those settings of the printing system which influence the physical image sharpness when a change in the image sharpness is measured.

The deviation rates indicated for the physically measured color and the physically measured image sharpness are merely relative measures and are not covered by any standard.

Despite this substantial improvement, German Patent Application 11 2004 000 051.3 does, however, not solve a further problem of human color perception of equal physiological significance, namely, the differences in perception of colored patterned surfaces between genetically and culturally different observers.

It is known from the literature on the genetic fundamentals of human color vision that female observers are capable of perceiving substantially more differentiated color shade gradations, in particular in the range of reddish shades, than male observers (see, e.g., Prof. Brian Verrelli, Arizona State University, in: Scientific American, September 2004).

In “Culture and Cognition: What is universal about the representation of color experiences?”, the author, Kimberley A. Jameson, Dept. of Psychology, University of California, San Diego (kjameson@aris.ss.uci.edu) summarizes the current state of discussion relating to the culture-specific and race-specific color perception of human beings. A specificity of the Asian population that has long been known to media designers, for example, is the different kind of assessment of shades of red. The advertising industry takes this into consideration in its work in an empirical manner, even though the special contributions of genetics and of culture to perception can not be clearly separated according to today's state of science.

It is known from most recent studies on the shift in the color shade as a function of the spatial frequency bandwidth that the color shade of a single-color surface shifts as the bandwidth rises. The increase in the bandwidth is obtained in tests in that a single-color surface is covered by black bars arranged increasingly densely (see Oliver Tulet: Preliminary Studies on the Influence of Spectral Bandwidth on Colour Appearance, pp. 307-310, 3rd European Conference on Colour in Graphics, Imaging and Vision, Jun. 19-22, 2006, University of Leeds, UK). These studies have shown that female observers perceive a bandwidth-dependent shift in the color shade of a single-color surface up to 5 times more sensitively than male observers. Even if it considers only single-color patterns, this paper thus supports at least indirectly the methods of the prior German patent application 11 2004 000 051.3.

The inventor's own investigations have shown that the color shift perceived as a result of a varying image sharpness is perceived considerably more intensively by women than by men also in the case of multicolor patterned images as are found in decorated floor coverings, for example.

However, most of the qualified staff in the printing industry, operating worldwide today, in particular the qualified staff working in special, high-quality decorative printing, who are responsible for the adjustment of the color print, are men of a particular culture. Accordingly, these men assess differences in single-color surfaces and also the differences indicated by the monitoring devices realized according to German patent application 11 2004 000 051.3 too tolerant with respect to the color statistics and the image sharpness when compared to the perception by women.

This too tolerant production may therefore lead to very costly complaints, in particular where decorated surfaces, e.g., in households, are concerned which are primarily judged by women, such as kitchen furniture, countertops, floors, etc.

The above-mentioned qualified staff also assess these tolerances differently from printers from a different culture group or of a different race since, according to today's state of science, color is perceived race- and culture-specifically.

We can therefore state that the human perception of multicolor patterned surfaces is determined to a great extent by genetics (sex and race) and by culture, and that the classical colorimetry, inclusive of imaging colorimetry and imaging spectrometry, does not offer any measuring rules, norms, etc. therefor.

There is therefore a great technical and economic interest in providing a system in particular for an automatic monitoring of the color impression of colored patterned surfaces, which displays the color impression measured in relation to a reference such that the deviation rate takes the differences in perception that are due to genetics and/or culture of the targeted customer group into consideration and is not determined by the specific perception of the printer.

According to the invention, this is achieved by a method having the features according to claim 1 or claim 2 and by an arrangement having the features according to claim 6 or 7. The multicolor patterned surface to be monitored is captured with at least one imaging sensor in at least two spectrally different ranges, and deviation rates are determined in relation to at least one reference of the spectral statistics and of the image sharpness of the n-channel image(s). The deviation rates are converted individually or in combinations by means of at least one transformation describing the genetically/culturally specific perception for multicolor patterned surfaces of the targeted customer group, and the transformed deviation value(s) is/are compared with at least one threshold. This provides a statement as to whether the surface possesses a quality that is sufficient for the targeted customer group. Rather than a transformation of the deviation rates, a transformation of the threshold values may also be performed.

The perception-responsive assessment according to the invention of the quality produced of a multicolor patterned surface in respect of genetic and cultural specificity not only allows the desired quality to be produced for a genetically/culturally specific customer group. It also allows the reject rate to be reduced and, hence, the productivity to be increased. For example, when a decorative pattern has been produced which can not be tolerated for a European, female perception, this production may be quite sufficient in terms of quality for a male customer group or in a culture less responsive to a RED shift.

Since many printers of decorative papers and decorative films produce locally but market globally, the method according to the invention allows a sufficient quality to be produced for a genetically/culturally known group of customers, instead of supplying the highest level of quality for a group of customers who are perceptionally unable to see this quality.

By way of summary, the concept of the invention therefore allows a measuring technique for the stability of the color impression of multicolor patterned surfaces produced to be offered which generates measured values that correspond to the geneticsculture-related sense for color of the customer group for multicolor patterned surfaces and therefore allow an appropriate adjusted quality assessment.

This measuring technique for multicolor patterned surfaces is of particular significance when it operates in the production line. But the concept of the invention also includes the use of the method in laboratory or hand-held measuring devices, as long as the application includes the assessment of multicolor patterned surfaces with an imaging n-channel color/spectral sensor and a genetically and/or culturally perception-relevant transformation of the deviation rates determined in relation to a reference.

In connection with the present application, for n=3 we speak of a color image sensor (a color camera with the spectral channels RED, GREEN, BLUE), for n>3 of an imaging spectrometry or an n-channel spectral camera. In addition, the concept of the invention also covers imaging sensors in which the color or spectral information is obtained in that the required images are taken with a single-channel sensor and a plurality of switched, spectrally different illumination sources. These methods are known to a person skilled in the art of image processing.

The concept of the invention will be explained by way of example using a system for a perception-responsive measurement of the color impression of multicolor patterned laminate floorings. These laminates show, for example, a printed wood decor with a high-frequency pattern of the wood grain. High-frequency in this context means a large number of light/dark transitions as related to a unit of length. As an example, for a simpler explanation of the concept of the invention, the genetic specificity is limited to the difference in sex of the observer, and the race- and culture-specific differences in perception are left out of consideration in this exemplary discussion.

Furthermore, the discussion will be limited to the sex-specific differences in perception of the color impression of a multicolor patterned surface under the impression of the image sharpness. The perception of single-color, i.e. non-patterned, surfaces in which necessarily no “image sharpness” exists, is not the subject matter of the concept of the invention.

The description is given with reference to the accompanying drawings, in which

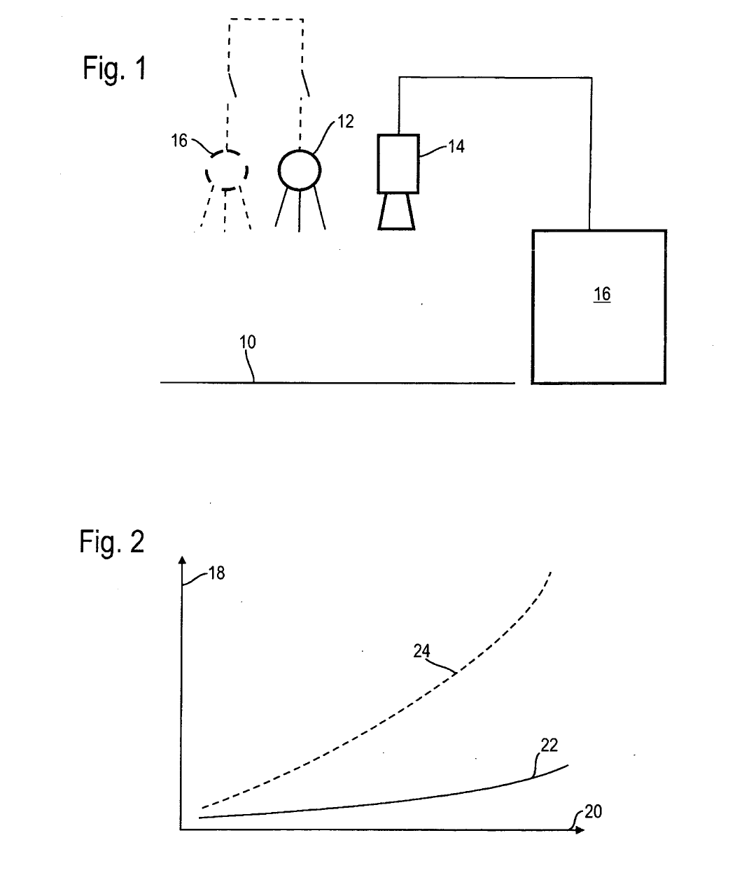

FIG. 1 schematically shows an arrangement according to the invention for carrying out the method according to the invention;

FIG. 2 shows a typical profile of the perception of the color impression of “reddishness” of a wood decor as a function of the image sharpness in a male and in a female observer;

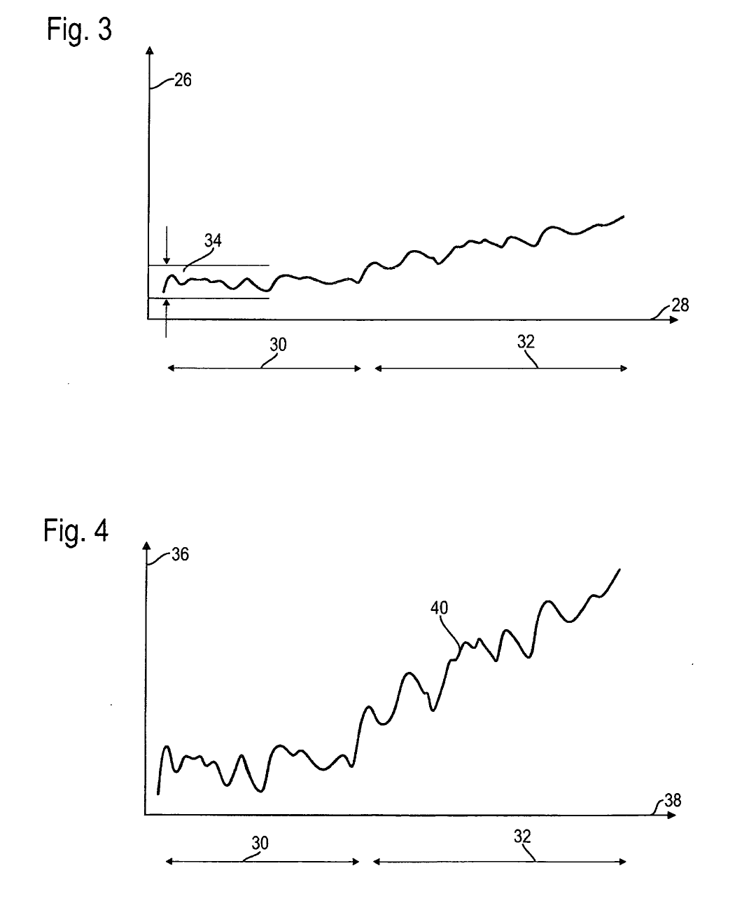

FIG. 3 shows a typical profile of a difference in image sharpness of a printed wood decor in comparison with a reference, plotted against production time;

FIG. 4 shows a display of the difference in image sharpness after a transformation according to the invention for the case of a production intended for a predominantly female group of customers.

FIG. 1 shows a surface 10 to be monitored, which is illuminated by an illumination source 12. A camera 14 is provided, which in one embodiment is a color camera with the three spectral channels RED, GREEN, BLUE and in a general case is an n-channel spectral sensor with at least two channels. Illustrated with dashed lines is a second illumination source 16 for an embodiment in which the camera involved is a single-channel sensor and spectrally different illumination sources 14, 16 are switched on alternately to obtain image information in different spectral ranges, for which reason switches are also illustrated in dashed lines. The signals of the camera 14 are supplied to an arithmetic unit 16 in any desired known manner. The arithmetic unit contains software programs which, using methods of image processing, allow a spectral statistics and an image sharpness to be determined from the pictures taken, allow the spectral statistics and the image sharpness to be compared with reference values, and a first deviation rate of the spectral statistics and a second deviation rate of the image sharpness to be calculated. Further, in the embodiment described, at least one of the two deviation rates is converted by means of a transformation rule which describes the genetically and/or culturally specific perception for multicolor patterned surfaces of a targeted customer group. In the exemplary embodiment, the arithmetic unit 16 further comprises a classifier which, on the basis of the transformed values, decides whether the quality of the surface is sufficient for the targeted customer group. Preferably, the arithmetic unit also includes a display unit which displays the transformed deviation rate(s).

FIG. 2 schematically shows a typical profile of the perception of the color impression of “reddishness” of a wood decor as a function of the image sharpness, i.e., the subjective color impression of “reddishness” is plotted on the ordinate 18 while the image sharpness is plotted on the abscissa 20. A continuous line 22 shows the subjective color impression in a male observer, whereas a dashed line 24 reproduces the color impression in a female observer. The sharper the printed image, the more reddish the decor thus appears to both observers. Here, this sensation, however, is approx. 5 times more strongly pronounced in the female observer as compared with the male observer.

In FIG. 3, the image sharpness difference of a printed wood decor is plotted on the ordinate 26 in comparison with a reference, i.e. one of the deviation rates determined in the arithmetic unit 16, while the abscissa 28 is a time axis.

The typical profile as illustrated of the image sharpness difference versus the production time shows a substantially stable profile in a first time period 30 and a slight drifting away in a second time period 32. In the second time period 32, the image sharpness increases and, in connection with FIG. 2, it becomes clear that this is accompanied by an increase in the “reddishness” perceived, and, in fact, substantially more markedly for a female observer than for a male observer. The representation of FIG. 3 corresponds to the manner of representation commonly used in the prior art so far, i.e. the relative deviation is directly plotted in the way as results from the relative deviations, that is, without a transformation according to the invention. An assumed male printer will orientate himself by the random variations in production, which are within a range 34, to distinguish between a stable profile in the first period 30 and a slight drifting away in the second period 32. He will learn within a short time to assess the amplitude of this ordinate in the interest of the quality of the color impression produced, even without having at his disposal a standardized deviation rate such as, for example, the rate ΔE of the traditional colorimetry that is limited to monochromaticity.

For the satisfaction of a female observer of the decor produced, however, this conventional, relative display is misleading. While the representation leads the male printer to believe that the situation is still harmless in period 32 since he still perceives no or at least only a barely noticeable red shift, in reality a decor is already produced which, for women, causes highly disturbingly visible shifts in color shade (in this case a so-called RED cast). For observers from a different cultural group or of a different race, the perception thresholds applicable are again different.

According to the invention, therefore, depending on the predominant sex (or on the race, on the culture) of the customer group for whom the current production is intended, the ordinate is automatically spread by means of a transformation rule such as corresponds to the difference in perception between a female and a male observer. FIG. 4 shows, as an example, the display of the difference in image sharpness for the case of a production intended for a predominantly female group of customers. As in FIG. 3, the difference in image sharpness of a printed wood decor is plotted on the ordinate 36 in comparison with a reference, while the time is plotted on the abscissa 38. The ordinate 36 is spread in accordance with the respective distance between the male 22 and the female 24 perception characteristic from FIG. 2, and in this way, the significance of this deviation in the curve profile 40 is directly made clear to the male printer. As is shown by a glance at FIG. 2, an increase in the image sharpness in the upper image sharpness range is thus stressed considerably more strongly, and the ordinate is considerably more strongly “spread” in this range than in the lower image sharpness range. A comparison of the merely schematic illustrations in FIGS. 3 and 4 shows that the rise in the curve 40 in FIG. 4 is considerably more distinct than that in the curve in FIG. 3.

The perception-specific transformation of the deviation measured between the image sharpness of the reference and that of the current production and the visual representation of the measured variable transformed are easier to interpret by a machine operator than a change in inserted tolerance fields in accordance with the genetic/cultural difference in perception, especially where relative and non-standardized measured variables are concerned. In addition to this, the machine operator only needs to select for which customer group the production is intended, without being informed of the particularity thereof, and can then assess the curve represented for him always in the same way.

The transformation illustrated here using the image sharpness as an example may be analogously transferred to a transformation of the deviation rate for the spectral distribution.

The concept of the invention is also not limited to the particularly favorable graphic representation of this embodiment, but covers any and all transformations of the measured variable which show to a person responsible for the quality of the production whether or not the differences produced in relation to a reference are still tolerated as sufficient quality in the genetically/culturally specific perception of the customer group supplied.

It is a matter of course to a person skilled in the art of testing engineering that it is equivalent whether the perception-specific transformation is applied to the deviation rates themselves or to the tolerances with which the deviations are compared. The first solution allows a visualization that is easier to interpret, which presents an advantage to the monitoring person in systems operating in the production line. The concept of the invention covers both variants of the method.

Also, the concept of the invention is not limited to the transformation of the physically measurable image sharpness as discussed in the explanatory exemplary embodiment. As already set forth in German patent application 11 2004 000 051.3, the representation of the difference in color statistics (e.g., the color histograms, the histograms of the multichannel spectral images) likewise has to be transformed according to the invention in line with a genetic/cultural perception characteristic curve before the differences produced are assessed qualitatively with a view to the genetic/cultural specificity of the customer group.

1. A method of monitoring the color impression of multicolor patterned surfaces by an evaluation of the color and the image sharpness, the method comprising the following steps:
capturing the surface to be monitored with an imaging sensor in at least two different spectral ranges;
determining the image sharpness of the pattern from signals of the imaging sensor in at least one spectral range;
determining the spectral statistics from the signals of the imaging sensor;
comparing the measured image sharpness with a reference image sharpness and determining a first deviation rate;
comparing the measured spectral statistics with a reference spectral statistics and determining a second deviation rate;
defining a first threshold value for the maximum permissible first deviation rate and defining a second threshold value for the maximum permissible second deviation rate;
converting at least one of the two deviation rates or a deviation rate combined from the two deviation rates by means of a transformation rule which describes the genetically and/or culturally specific perception for multicolor patterned surfaces of a targeted customer group;
comparing the at least one transformed deviation rate with the associated threshold value to decide whether the surface possesses a quality that is sufficient for the targeted customer group.

2. A method of monitoring the color impression of multicolor patterned surfaces by an evaluation of the color and the image sharpness, the method comprising the following steps:
capturing the surface to be monitored with an imaging sensor in at least two different spectral ranges;
determining the image sharpness of the pattern from signals of the imaging sensor in at least one spectral range;
determining the spectral statistics from the signals of the imaging sensor;
comparing the measured image sharpness with a reference image sharpness and determining a first deviation rate;
comparing the measured spectral statistics with a reference spectral statistics and determining a second deviation rate;
defining a first threshold value for the maximum permissible first deviation rate and defining a second threshold value for the maximum permissible second deviation rate;
converting at least one of the two threshold values by means of a transformation rule which describes the genetically and/or culturally specific perception for multicolor patterned surfaces of a targeted customer group;
comparing the associated deviation rate with the at least one transformed threshold value to decide whether the surface possesses a quality that is sufficient for the targeted customer group.

3. The method according to claim 1, further comprising
evaluating the transformed deviation rates using a classification rule, so that that or those genetically and/or culturally specific group(s) of customers are determined whose perception perceives the quality produced as being sufficient.

4. The method according to claim 1, wherein the transformed deviation rates are calculated to form a total deviation rate and the quality produced is judged on the basis of this rate.

5. The method according to claim 1, wherein the surface to be inspected is manufactured in a printing method and, during the printing process, the transformed values are continuously graphically represented over time and, based on the representation, an inspector realizes when to perform which correction to the printing device.

6. An arrangement for carrying out a method of monitoring the color impression of multicolor patterned surfaces by an evaluation of the color and the image sharpness, the arrangement comprising:
an n-channel spectral sensor with n equal to or greater than 2, which is arranged to capture a multicolor patterned surface to be inspected;
an illumination source which is arranged to illuminate the surface;
an arithmetic unit which receives the signals of the spectral sensor and, using methods of image processing, determines from the signals of the spectral sensor a spectral statistics and an image sharpness, compares them with reference values, and calculates a first deviation rate of the spectral statistics and a second deviation rate of the image sharpness, and converts at least one of the two deviation rates or a predefined first threshold value for the maximum permissible first deviation rate and/or a second threshold value for the maximum permissible second deviation rate by means of a transformation rule which describes the genetically and/or culturally specific perception for multicolor patterned surfaces of a targeted customer group.

7. An arrangement for carrying out a method of monitoring the color impression of multicolor patterned surfaces by an evaluation of the color and the image sharpness, the arrangement comprising:
a single-channel spectral sensor which is arranged to capture a multicolor patterned surface to be inspected;
at least two illumination sources which have different spectral ranges and are arranged to illuminate the surface;
a switching device for serially switching the illumination sources on and off;
an arithmetic unit which receives the signals of the spectral sensor and, using methods of image processing, determines from the signals of the spectral sensor a spectral statistics and an image sharpness, compares them with reference values, and calculates a first deviation rate of the spectral statistics and a second deviation rate of the image sharpness, and converts at least one of the two deviation rates or a predefined first threshold value for the maximum permissible first deviation rate and/or a second threshold value for the maximum permissible second deviation rate by means of a transformation rule which describes the genetically and/or culturally specific perception for multicolor patterned surfaces of a targeted customer group.

8. The arrangement according to claim 6, further comprising:
a classifier which, on the basis of the transformed value(s), decides in accordance with fixed criteria whether the quality of the surface is sufficient for a targeted customer group.

9. The arrangement according to claim 7, further comprising:
a classifier which, on the basis of the transformed value(s), decides in accordance with fixed criteria whether the quality of the surface is sufficient for a targeted customer group.
